(19) United States
(12) Patent Application Publication
(10) Pub. No.: US 2006/0033052 A1
(43) Pub. Date: Feb. 16, 2006

(54) Curing light with ramped or pulsed leds

(76) Inventor: Robert R. Scott, Riverton, UT (US)

Correspondence Address: RICK D. NYDEGGER;WORKMAN, NYDEGGER & SEELEY, 1000 Eagle Gate Tower, 60 East South Temple, Salt Lake City, UT, 84111, US

(21) Appl. No.: 10/916,283

(22) Filed: Aug. 11, 2004

(51) Int. Cl. G01J 1/00

(52) U.S. Cl. 250/495.1; 250/494.1

(57) ABSTRACT

An LED curing light having controlled spectral output. The LED curing light includes two or more LEDs that emit light at different wavelengths and means for selectively and independently controlling the output of each LED as a function of time so as to independently ramp and/or pulse one or more of the LEDs. The LED curing light can be programmed to mimic the light output of a conventional light source so as to, e.g., have a shifting Kelvin rating or warm the curable composition prior to curing it.

### BACKGROUND OF THE INVENTION

1. The Field of the Invention

The invention relates to devices and related methods for curing photosensitive compounds.

2. The Relevant Technology

In the field of dentistry, dental cavities are often filled and/or sealed with photosensitive compounds that are cured by exposure to radiant energy, such as visible light. These compounds, commonly referred to as light-curable compounds, are placed within dental cavity preparations or onto dental surfaces where they are subsequently irradiated by light. The radiated light causes photosensitive components within the compounds to polymerize, thereby hardening the light-curable compounds within the dental cavity preparation or another desired location.

Existing light-curing devices are typically configured with a light source, such as a quartz-tungsten-halogen (QTH) lamp or an LED light source. QTH lamps are particularly useful because they are configured to generate a broad spectrum of light that can be used to cure a broad range of products. In particular, a QTH lamp is typically configured to emit a continuous spectrum of light in a preferred range of about 350 nm to about 500 nm. Some QTH lamps may even emit a broader spectrum of light, although filters are typically used to limit the range of emitted light to the preferred range mentioned above.

One reason it is useful for the QTH lamp to emit a broad spectrum of light is because many dental compounds cure at different wavelengths. For example, camphorquinone is a common photo-initiator that is most responsive to light having a wavelength of about 455 nm to about 470 nm, within the blue range of the spectrum. Other light-curable products, however, including many adhesives, are cured when they are irradiated by light wavelengths in the 350 nm to 400 nm, within the UV range of the spectrum. Accordingly, QTH lamps can be used to cure both camphorquinone initiated products as well as other light-curable products that are most effectively cured with UV light.

One drawback of QTH lamps (and other bulb light sources) is that they are not very efficient. In particular, they produce significant amounts of heat, and light radiation outside the desired ranges must be filtered. This is a problem because it generally results in increased power requirements for generating a desired output of radiation. Another problem experienced by QTH light-curing devices, is that complicated cooling systems are often required to compensate for the significant amount of heat that is generated.

In an attempt to overcome the aforementioned problems, some light-generating devices have been manufactured using alternative light generating sources, such as light-emitting diodes (LEDs) which are generally configured to only radiate light at specific or narrow ranges of wavelengths, thereby eliminating the need for special filters and generally reducing the amount of input power required to generate a desired output of radiation.

LEDs are particularly suitable light sources because they generate much less heat than QTH lamps, thereby enabling the LEDs to be placed at the tip of the curing lights and to be inserted directly within the patient's mouth. This is particularly useful for reducing or eliminating the need for light guides such as optical fiber wands.

One limitation of LEDs, however, is that they are only configured to emit a narrow spectrum of light. For example, a 455 nm LED or LED array will generally only emit blue light having a spectrum of 455 nm±30 nm. Accordingly, a light curing device including a 455 nm blue LED light source will be well designed to cure camphorquinone initiated products, but will not be suitable for curing adhesives that are responsive to UV light in the 380 nm±30 nm range. Likewise, a light-curing device including a 380 nm UV light source may be suitable for curing some adhesives, but will be unsuitable for curing camphorquinone initiated products.

Some photocurable compositions may be most effectively cured if exposed to a light source with a shifting Kelvin rating as a function of time, especially during the first few seconds of curing. Halogen lamps generally provide a shifting Kelvin rating during warm up that is believed to affect curing of photocurable compositions. For example, when a halogen lamp is turned on, it takes time to fully heat the filament, resulting in a shift in the Kelvin rating of a “white” lamp as a function of time. For example, it often takes 2 to 3 seconds to produce a significant level of UV light. LEDs do not naturally exhibit this shifting Kelvin rating behavior.

In view of the foregoing, it would be an improvement in the art to provide an LED curing light including multiple LEDs so as to emit a broader spectrum than what is possible using a single LED, and that is also capable of producing a shifting Kelvin rating so as to allow more effective curing of photocurable compositions.

### BRIEF SUMMARY OF THE INVENTION

The present invention is directed to an LED curing light having controlled spectral output. The LED curing light includes two or more LEDs or LED arrays that emit light at different wavelengths and means for selectively and independently controlling the output of each LED or LED array as a function of time so as to independently ramp and/or pulse one or more of the LEDs or LED arrays.

The LED curing light may include LEDs or LED arrays that emit any desired wavelength of light. According to one embodiment, at least one of the two or more LEDs or LED arrays emit UV light, for example having a mean dominant wavelength of about 380 nm. Such an LED or LED array is useful in curing photocurable compositions that are cured by exposure to UV light. The LED curing light may include LEDs or an LED array that emits blue light, for example having a mean dominant wavelength of about 455 nm. Such an LED or LED array is useful in curing photocurable compositions (e.g., camphorquinone) that are cured by exposure to blue light.

According to one embodiment, the LED curing light includes an infrared LED or LED array. Such an LED or LED array may be useful for initially warming a photocurable composition before curing with blue and/or UV light. Preheating the composition can increase both the rate and extent of polymerization, resulting in a faster, more complete cure.

In use, the LED curing light is operated so as to selectively and independently control the output of each LED or LED array as a function of time so as to independently ramp and/or pulse one of more of the LEDs or LED arrays. For example, an LED curing light having blue and UV LEDs may mimic a halogen lamp by ramping the UV LED so as to produce a shifting Kelvin rating.

According to one embodiment, the LED curing light may further include means for selectively and independently controlling the output of one or more of the LEDs or LED arrays so as to overdrive one or more of the LEDs or LED arrays.

The means for selectively and independently controlling the output of each LED or LED array as a function of time so as to independently ramp and/or pulse one or more of the LEDs or LED arrays, and the means for selectively and independently controlling the output of one or more of the LEDs or LED arrays so as to overdrive one or more of the LEDs or LED arrays may comprise circuitry in communication with one or more of the LEDs or LED arrays.

These and other benefits, advantages and features of the present invention will become more fully apparent from the following description and appended claims, or may be learned by the practice of the invention as set forth hereinafter.

### BRIEF DESCRIPTION OF THE DRAWINGS

In order that the manner in which the above recited and other benefits, advantages and features of the invention are obtained, a more particular description of the invention briefly described above will be rendered by reference to specific embodiments thereof which are illustrated in the appended drawings. Understanding that these drawings depict only typical embodiments of the invention and are not therefore to be considered limiting of its scope, the invention will be described and explained with additional specificity and detail through the use of the accompanying drawings in which:

FIG. 1 illustrates a graph charting the spectral irradiance of a 380 nm LED, a 430 nm LED, a 455 nm LED and a quartz Halogen Tungsten (QTH) bulb;

FIG. 2 illustrates one embodiment of a curing light of the present invention that includes two different LED light sources that are disposed at the distal end of the curing light;

FIG. 3A illustrates a graph charting an exemplary output of light emitted from an LED when the LED is pulsed;

FIG. 3B illustrates a graph charting an exemplary output of light emitted from an LED when the LED is ramped;

FIG. 3C illustrates a graph charting an exemplary output of light emitted from an LED when the LED is ramped and then pulsed;

FIG. 4 illustrates one embodiment of a curing light of the invention that includes five LED light sources that are disposed at the distal end of the curing light; and

FIG. 5 illustrates a graph charting the output of light emitted from a 380 nm UV LED that is ramped and blended with a 455 nm blue LED.

### DETAILED DESCRIPTION OF THE PREFERRED EMBODIMENTS

I. Introduction

A detailed description of preferred embodiments of the invention will now be provided with specific reference to Figures illustrating various embodiments of the inventive LED curing light. It will be appreciated that like structures will be provided with like reference designations.

To help clarify the scope of the invention, certain terms will now be defined. The term “LED light source,” as used herein, generally refers to one or more LEDs, one or more LED arrays, or any combination of the above that is capable of generating radiant energy that can be used to cure light curable compounds. The light emitted by an LED light source includes a limited spectrum of wavelengths that corresponds with the rating of the LED light source. Each type of LED typically emits at a mean dominant wavelength.

According to one embodiment, the light-curing devices of the invention are configured with two or more LED light sources that emit light at different wavelengths, and means for selectively and independently controlling the output of each LED light source as a function of time so as to independently ramp and/or pulse one or more of the LED light sources.

According to one embodiment, the curing light is configured with LED light sources configured to only emit light having wavelengths that are used for curing photo-sensitive compounds, rather than emitting a broader spectrum that includes unused wavelengths.

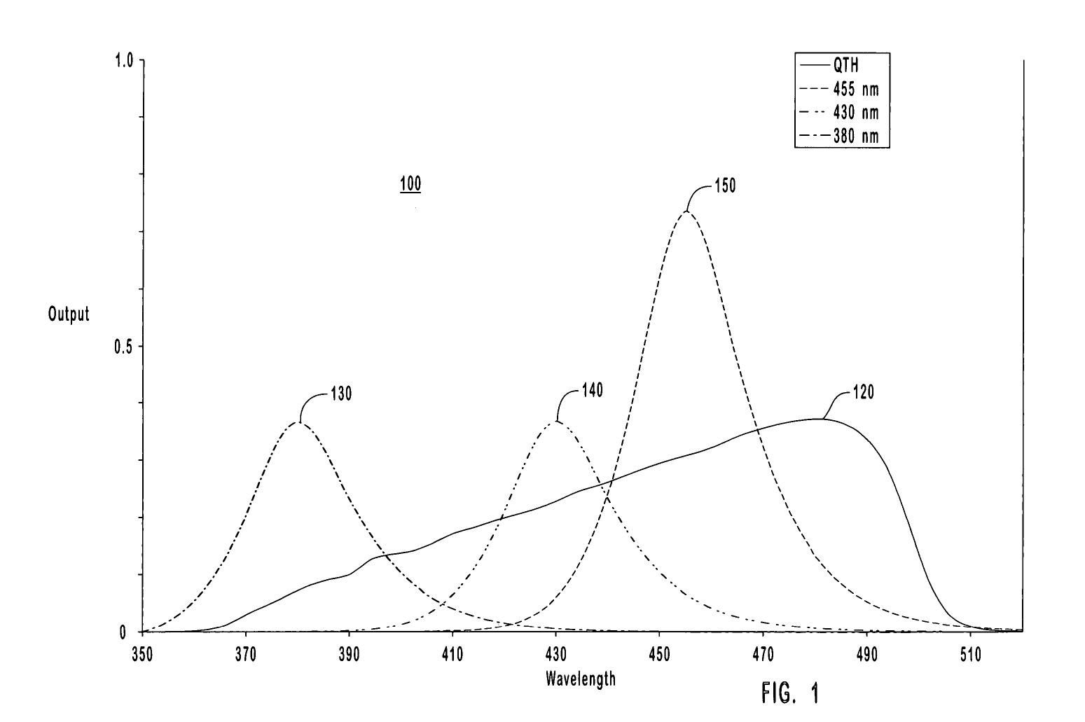

FIG. 1 illustrates a graph 100 that charts the spectral irradiance or light spectra emitted from by a quartz-tungsten-halogen (QTH) bulb, a 380 nm LED light source, a 430 nm LED light source, and a 455 nm LED light source. The values given in the y-axis are generic such that no specific representation as to the actual power output should be assumed.

As shown in FIG. 1, the QTH spectrum 120 ranges from about 360 nm to about 510 nm. The 380 nm LED spectrum 130 ranges from about 340 nm to about 430 nm, with the most intense output of light being within the range of about 360 nm to about 400 nm. The 430 nm LED spectrum 140 ranges from about 390 nm to about 480 nm, with the most intense output of light being within the range of about 410 nm to about 450 nm. The 455 nm LED spectrum 150 ranges from about 405 nm to about 505 nm, with the most intense output of light being within the range of about 425 nm to about 475 nm.

Also shown, each of the individual LED spectra 130, 140, and 150 individually comprise only a portion of the spectral range of wavelengths emitted by QTH spectrum 120. Accordingly, the utility of the LED spectra 130, 140 and 150 is somewhat more specialized or limited than the spectral irradiance of the QTH spectrum 120. In particular, the QTH spectrum 120 can be used to cure adhesives that are responsive to light at about 380 nm as well as camphorquinone initiated products that are responsive to light at about 455 nm. In contrast, none of the individual LED spectra 130, 140 or 150 can be used to effectively cure both camphorquinone initiated products with 455 nm light as well as adhesives with 380 nm light.

The curing lights of the present invention are configured with a plurality of different types of LED light sources, as described below, to generate a composite spectrum of light that is broader than a spectrum of light provided by any single LED light source. In addition, the curing lights include means for selectively and independently controlling the output of each LED light source as a function of time so as to independently ramp and/or pulse one or more of the LED light sources. According to one embodiment, the means for selectively and independently controlling the output of each LED light source as a function of time so as to independently ramp and/or pulse one or more of the LED light sources may comprise circuitry in communication with one or more of the LED light sources.

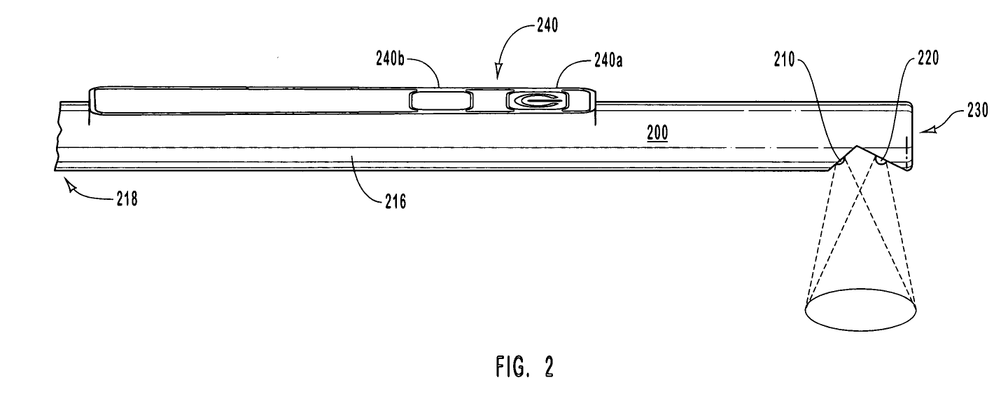

FIG. 2 illustrates one embodiment of a curing light 200 that has been configured with two LED light sources 210 and 220. As shown, the curing light includes a body 216 that is configured to be held in the hand of a dental practitioner and that extends from a proximal end 218 to a distal end 230. According to one embodiment, the LED light sources 210 and 220 are disposed at the distal end 230 of the curing light 200 in such a manner that they are configured for insertion within the mouth of a patient. The LED light sources are also mounted to emit the light somewhat orthogonally away from the body of the curing light. It will be appreciated that this can be useful for eliminating any requirement for ancillary light-guides. This, however, does not mean that the curing light 200 will not be used with lenses, which are distinguished from light-guides. Lenses may be used, for example, to focus the light from the LED light sources into more collimated beams or rather to disperse the light in some desired manner. Lenses or other devices can also be used to blend the light emitted from a plurality of LED light sources. A lens may, for example, be mounted at the distal end 230 of the curing light 200 over the LED light sources 210 and 220.

Furthermore, although the LED light sources 210 and 220 are shown mounted to opposing faces of the curing light 200, it will be appreciated that the LED light sources 210 and 220 can be mounted in any fashion or geometric arrangement on the curing light 200.

According to one embodiment, the first LED light source 210 may include a 380 nm LED configured to emit a spectrum of light similar to spectrum 130 of FIG. 1 and the second LED light source 220 may include a 455 nm LED configured to emit a spectrum of light similar to spectrum 150 of FIG. 1. Of course the LED light sources 210 and 220 may be disposed in alternate locations on the curing light 200.

Each LED light source can be selectively and independently controlled so as to independently ramp and/or pulse one or more of the LED light sources. For example, it may be desirable to ramp the output of LED light source 210, which may be a UV LED light source that emits light centered around 380 nm. Ramping the output of the UV LED light source mimics the behavior of QTH bulbs, which do not emit a significant intensity of UV light for the first 2 to 3 seconds.

Activating the LED curing light, ramping and/or pulsing one or more of the LED light sources, along with any other function such as duration or overdrive may be accomplished through use of controls 240 located on the body 216 of the curing light 200. The controls 240 are connected to the LED light sources through internal circuitry (not shown).

According to one embodiment, the controls may include one button 240a for activating the LED curing light, and another button 240b for selecting an operation mode and for selecting the duration of the light activation. According to one embodiment, the user may press button 240b to select between various duration times. The user may press and hold button 240b (e.g., 3 seconds) to change operation modes so as to ramp and/or pulse one or more of the LED light sources. Operation modes may be programmed into the LED curing light so as to allow the user to easily toggle through and select one of the available modes.

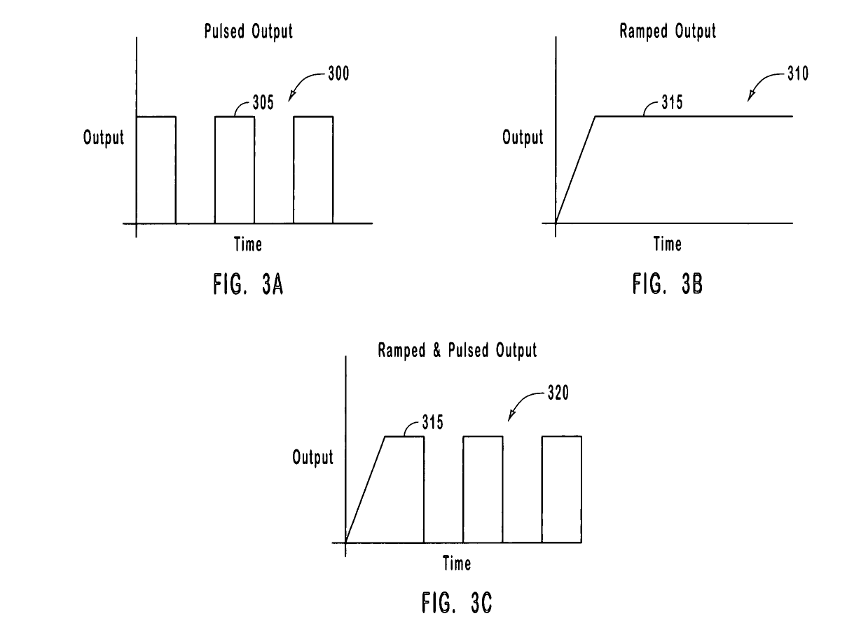

FIG. 3A illustrates a graph 300 charting the output of light that is emitted from an LED light source as a function of time. The output values given in the y-axis are generic. As shown, the output 305 is pulsed. The duration of the pulses may be any desirable duration. The time between pulses may also be any length desired. Pulsing the output of one or more of the LED light sources may be desirable and result in a more effective and complete cure of the photosensitive compound.

FIG. 3B illustrates a graph 310 charting the output of light that is emitted from an LED light source as a function of time. The output values given in the y-axis are generic. As shown, the output 315 is ramped. The slope of the ramp may be any desirable slope. Ramping the output of one or more of the LED light sources may be desirable and result in a more effective and complete cure of the photosensitive compound.

FIG. 3C illustrates a graph 320 charting the output of light that is emitted from an LED light source as a function of time. The output values given in the y-axis are generic. As shown, the output 325 is ramped and then pulsed. The slope of the ramp may be any desirable slope. The duration of the pulses may be any desirable duration. The time between pulses may also be any length desired.

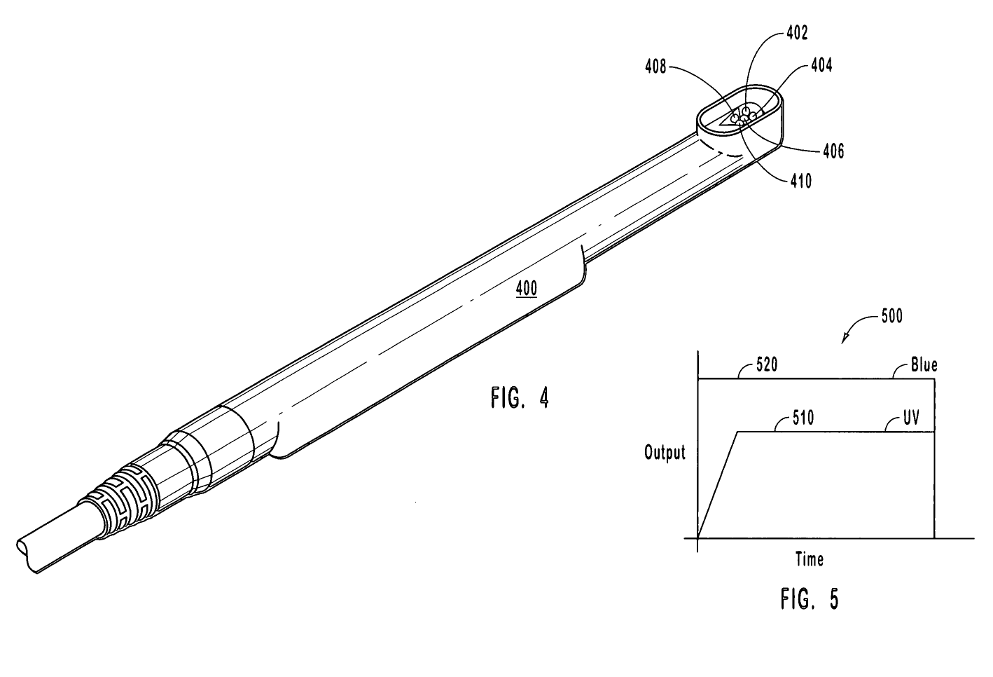

FIG. 4 illustrates an LED curing light 400 that has been configured with five LED light sources 402, 404, 406, 408, and 410 disposed at the tip of the curing light 400, which is configured to be inserted within the mouth of a patient. As shown, the LED light sources 402, 404, 406, 408, and 410 can be geometrically arranged and mounted on opposing faces to emit light in overlapping beams, although this is not required.

The LED light sources 402, 404, 406, 408, and 410 include LED light sources that emit at least two different wavelengths (e.g., one ore more of the LED light sources may emit blue light, while one or more of the remaining LED light sources emit UV light).

According to one embodiment, the LED light sources 402, 404, 406, 408, and 410 include one or more 380 nm LEDs and one or more 455 nm LEDs. Accordingly, the 455 nm LED(s) can be used to cure camphorquinone initiated products. Likewise, the 380 nm LED(s) may be used to cure adhesives. It will be appreciated that the curing light 400 may also include additional LEDs configured to emit any desired spectrum (e.g., an infrared LED that may be ramped so as to preheat a photosensitive compound).

It will be appreciated that the LED light sources 402, 404, 406, 408, and 410 can be controlled selectively and independently through controls that are disposed on the curing light 400, to ramp and/or pulse any of the LEDs so as to produce any desired output.

According to one embodiment, the LED curing light may further include means for selectively and independently controlling the output of one or more of the LED light sources so as to overdrive one or more of the LED light sources. The means for selectively and independently controlling the output of one or more of the LED light sources so as to overdrive one or more of the LED light sources may comprise circuitry in communication with one or more of the LED light sources.

FIG. 5 illustrates a graph 500 charting the output of light that is emitted from an exemplary LED curing light having both blue (e.g., 455 nm) and UV (e.g., 380 nm) LED light sources. The output values given in the y-axis are generic. As shown, the output 510 of the UV LED is ramped while the output 520 of the blue LED is not. This embodiment may be useful for mimicking the UV and blue wavelengths output from a QTH bulb.

Notwithstanding the foregoing examples, it should be understood that the invention embraces the use of any configuration of LEDs that emit at two or more different wavelengths, with means for selectively and independently controlling the output of each LED light source so as to independently ramp and/or pulse one or more of the LED light sources.

Non-limiting examples of LEDs that may be used within curing lights within the scope of the invention emit the following dominant or peak wavelengths: 350 nm, 370 nm, 375 nm, 380 nm, 385 nm, 393 nm, 395 nm, 400 nm, 405 nm, 410 nm, 430 nm, 450 nm, 455 nm, 460 nm, 465 nm, and infrared LEDs exhibiting wavelengths of between about 750 nm and about 6000 nm.

It will also be appreciated that the present claimed invention may be embodied in other specific forms without departing from its spirit or essential characteristics. The described embodiments are to be considered in all respects only as illustrative, not restrictive. The scope of the invention is, therefore, indicated by the appended claims rather than by the foregoing description. All changes that come within the meaning and range of equivalency of the claims are to be embraced within their scope.

What is claimed is:

1. An LED curing light having controlled spectral output, comprising:
at least one LED light source configured to emit light having a first mean dominant wavelength;
at least one other LED light source configured to emit light having a second mean dominant wavelength different from the first mean dominant wavelength; and
selection means for selectively and independently controlling the output of each LED light source as a function of time so as to independently ramp and/or pulse the intensity of light emitted by the LED light sources as a function of time.

2. An LED curing light as recited in claim 1, wherein at least one of said LED light sources comprising a UV LED configured to emit UV light.

3. An LED curing light as recited in claim 2, wherein said selection means ramps said UV LED as a function of time.

4. An LED curing light as recited in claim 2, wherein said selection means causes said UV LED to initially produce a lower intensity of UV light and then increase the intensity of UV light so as to reach a maximum intensity after about 2-3 seconds from when at least one other of the LED light sources begins to emit light.

5. An LED curing light as recited in claim 1, wherein at least one of said LED light sources is a blue LED configured to emit blue light.

6. An LED curing light as recited in claim 1, wherein said LED light sources comprise at least one blue LED configured to emit blue light and at least one UV LED configured to emit UV light.

7. An LED curing light as recited in claim 1, wherein at least one of said LED light sources comprises an infrared LED configured to emit infrared light.

8. An LED curing light as recited in claim 7, wherein at least one other of said LED light sources comprises a blue LED configured to emit blue light.

9. An LED curing light as recited in claim 7, wherein at least one other of said LED light sources comprises a UV LED configured to emit UV light.

10. An LED curing light as recited in claim 7, wherein said selection means causes said infrared LED to begin emitting light before at least one other of said LED light sources begins to emit light.

11. An LED curing light as recited in claim 1, wherein said LED light sources comprise five LED light sources.

12. An LED curing light as recited in claim 1, wherein said selection means comprises circuitry in communication with one or more of said LED light sources.

13. An LED curing light as recited in claim 1, further comprising overdrive means for selectively and independently controlling the output of at least one of said LED light sources as a function of time so as to independently overdrive one or more of said LED light sources.

14. An LED curing light as recited in claim 13, wherein said overdrive means comprises circuitry in communication with one or more of said LED light sources.

15. An LED curing light designed so as to at least partially mimic the behavior of a QTH curing light, comprising:
at least one blue LED configured to emit blue light;
at least one UV LED configured to emit UV light; and
control circuitry configured so as to activate and fully illuminate the blue LED and so as to ramp the UV LED as a function of time so as to become fully illuminated after said blue LED is fully illuminated.

16. An LED curing light as recited in claim 15, wherein said control circuitry is configured so as to cause said UV LED to initially produce a lower intensity of UV light and then increase the intensity of UV light so as to reach a maximum intensity after about 2-3 seconds from when said blue LED begins to emit light.

17. An LED curing light as recited in claim 15, further comprising at least one infrared LED configured to emit infrared light.

18. An LED curing light as recited in claim 15, further comprising control circuitry configured so as to activate and illuminate said infrared LED prior to illuminating at least one of said blue or UV LEDs.

19. An LED curing light designed so as to at least partially mimic the behavior of a QTH curing light, comprising:
at least one infrared LED configured to emit infrared light;
at least one other LED light source configured to emit a different wavelength of light; and
control circuitry configured so as to activate and illuminate said at least one infrared LED prior to illuminating at least one other of said LED light sources.

20. An LED curing light as recited in claim 19, said at least one other LED light source comprising at least one blue LED.

21. An LED curing light as recited in claim 19, said at least one other LED light source comprising at least one UV LED.

22. A method of using an LED curing light comprising:
providing an LED curing light as recited in claim 1;
selectively and independently controlling the output of each LED light source as a function of time so as to independently ramp and/or pulse one or more of said LED light sources.

23. A method as recited in claim 22, wherein:
said LED curing light includes at least one blue LED configured to emit blue light and at least one UV LED configured to emit UV light; and
said at least one UV LED is selectively ramped as a function of time.

24. A method as recited in claim 22, wherein:
said LED curing light includes at least one infrared LED configured to emit infrared light and at least one UV LED configured to emit UV light; and
said at least one UV LED is selectively ramped as a function of time.

25. A method as recited in claim 22, wherein at least one of said LED light sources is pulsed.

26. A method as recited in claim 22, wherein at least one of said LED light sources is overdriven.
